(19) United States
(12) Patent Application Publication
(10) Pub. No.: US 2013/0290546 A1
(43) Pub. Date: Oct. 31, 2013

(54) MECHANISM FOR EMPLOYING AND FACILITATING DYNAMIC AND REMOTE MEMORY COLLABORATION AT COMPUTING DEVICES

(71) Applicants: Ahmad Samih, Beaverton, OR (US); Ren Wang, Portland, OR (US); Christian Maciocco, Portland, OR (US); Tsung-Yuan C. Tai, Portland, OR (US)

(72) Inventors: Ahmad Samih, Beaverton, OR (US); Ren Wang, Portland, OR (US); Christian Maciocco, Portland, OR (US); Tsung-Yuan C. Tai, Portland, OR (US)

(21) Appl. No.: 13/977,692

(22) PCT Filed: Oct. 7, 2011
(86) PCT No.: PCT/US2011/055484

§ 371 Date: Jun. 29, 2013

(51) Int. Cl. H04L 12/70

(52) U.S. Cl. CPC H04L 47/781
USPC 709/226

(57) ABSTRACT

A mechanism is described for facilitating dynamic and remote memory collaboration at computing devices according to one embodiment of the invention. A method of embodiments of the invention includes dynamically classifying a computing device of a plurality of computing devices as a memory server, where the plurality of computing devices are coupled to each other over a network. The method may further include offering, by the memory server, of memory to be used by one or more of the plurality of computing devices classified as one or more memory clients, and remotely granting, by the memory server, of the memory to the one or more memory clients.

### FIELD

The field relates generally to computing devices and, more particularly, to employing a mechanism for employing and facilitating dynamic and remote memory collaboration at computing devices.

### BACKGROUND

With every new software generation, software applications' memory footprints are growing exponentially, such as outpacing the growth in the capacity of current memory systems (e.g., Random-Access Memory (RAM)). This typically causes an operating system (OS) to start paging in and out of various memory disks (e.g., Hard Disk Drive (HDD), Solid State Drive (SDD), etc.) which operate at several orders of magnitude slower than RAM. Improving performance with larger local memory is not without excessive cost and power implications. Further, current memory technologies usually operate on static configurations and are incapable of handling dynamic changing of the workload conditions.

### BRIEF DESCRIPTION OF THE DRAWINGS

Embodiments of the present invention are illustrated by way of example and not by way of limitation in the figures of the accompanying drawings, in which like references indicate similar elements and in which:

FIG. 1 illustrates a computing device employing memory collaboration mechanism according to one embodiment of the invention;

FIG. 2 illustrates memory collaboration mechanism employed at a computing device according to one embodiment of the invention;

FIGS. 3A-3B illustrate memory collaboration mechanism facilitating dynamic and remote memory collaboration at computing devices according to one embodiment of the invention;

FIG. 4A illustrates a transaction sequence classification of computing devices for dynamic and remote memory collaboration according to one embodiment of the invention;

FIGS. 4B-4C illustrate a transaction sequence between a memory server and a memory client for dynamically and remotely collaborating memory according to one embodiment of the invention;

FIGS. 4D-4E illustrate a method for facilitating dynamic and remote memory collaborating between computing devices according to one embodiment of the invention; and

FIG. 5 illustrates a computing system according to one embodiment of the invention.

### DETAILED DESCRIPTION

Embodiments of the invention provide a mechanism for facilitating dynamic and remote memory collaboration at computing devices according to one embodiment of the invention. A method of embodiments of the invention includes dynamically classifying a computing device of a plurality of computing devices as a memory server, where the plurality of computing devices are coupled to each other over a network. The method may further include offering, by the memory server, of memory to be used by one or more of the plurality of computing devices classified as one or more memory clients, and remotely granting, by the memory server, of the memory to the one or more memory clients.

In one embodiment, various computing nodes (e.g., computing devices) in a cluster and/or within a network are enabled to dynamically discover, allocate, and de-allocate remote memory to each other. This technique greatly increases performance, energy efficiency and reduces memory provisioning costs, etc. For example, the nodes may be connected to each other through a communication network (e.g. data center network/intranet, cloud computing, Internet, etc.) or network interconnect (e.g., Ethernet, Infiniband®, Light Peak®, etc.), allowing them to communicate and access remote memory. It a network setting of computing nodes, some computing nodes at certain time periods can have plenty of free memory and that other nodes that are short of memory could use. In one embodiment, a memory collaboration mechanism is employed and run at computing nodes that are available to participate in memory sharing. The memory collaboration mechanism, as will be further described with reference to the subsequent figures, allows for monitoring of local memory dynamics (e.g., using a node classification algorithm), communicate memory requirements with remote computing nodes, and dynamically coordinate memory sharing among computing nodes based on run-time conditions to facilitate remote memory access to achieve, for example, better performance and energy efficiency.

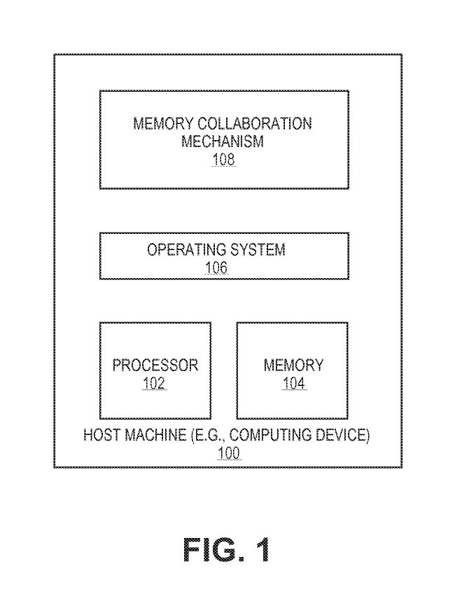

FIG. 1 illustrates a computing device employing memory collaboration mechanism according to one embodiment of the invention. In one embodiment, a host machine/computing device 100 is illustrated as having memory collaboration mechanism 108 to facilitate dynamic memory sharing at multiple computing devices. Computing device 100 may include mobile computing devices, such as cellular phones including smartphones (e.g., iPhone®, BlackBerry®, etc.), handheld computing devices, personal digital assistants (PDAs), etc., tablet computers (e.g., iPad®, Samsung® Galaxy Tab®, etc.), laptop computers (e.g., notebooks, netbooks, etc.), e-readers (e.g., Kindle®, Nook®, etc.), etc. Computing device 100 may further include set-top boxes (e.g., Internet-based cable television set-top boxes, etc.), and larger computing devices, such as desktop computers, server computers, cluster-based computers, etc.

Computing device 100 includes an operating system 106 serving as an interface between any hardware or physical resources of the computer device 100 and a user. Computing device 100 further includes one or more processors 102, memory devices 104, network devices, drivers, or the like, as well as input/output sources, such as touchscreens, touch panels, touch pads, virtual or regular keyboards, virtual or regular mice, etc. It is to be noted that terms like “node”, “computing node”, “client”, “memory client”, “server”, “memory server”, “machine”, “device”, “computing device”, “computer”, “computing system”, “cluster based computer”, and the like, are used interchangeably and synonymously throughout this document.

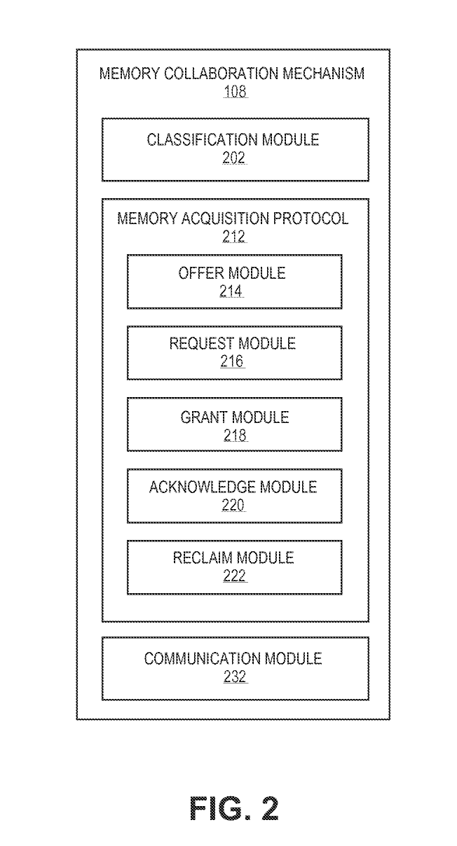

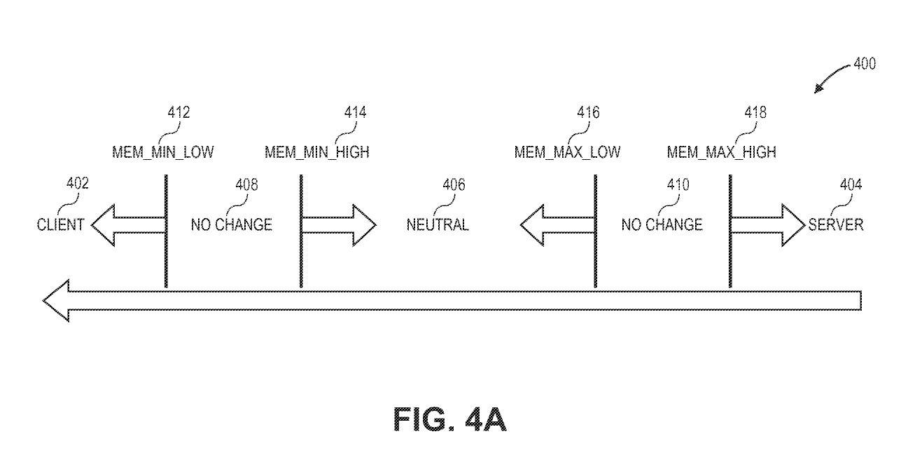

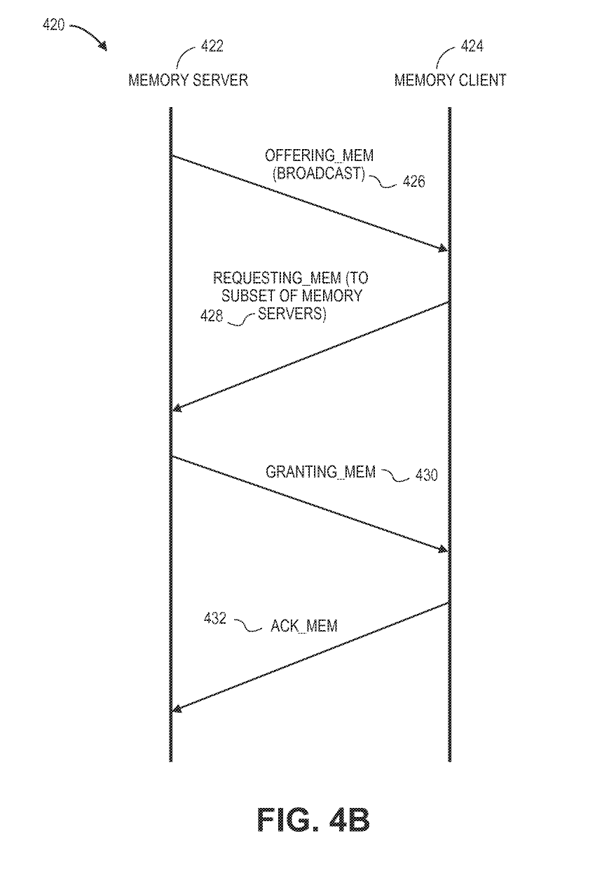

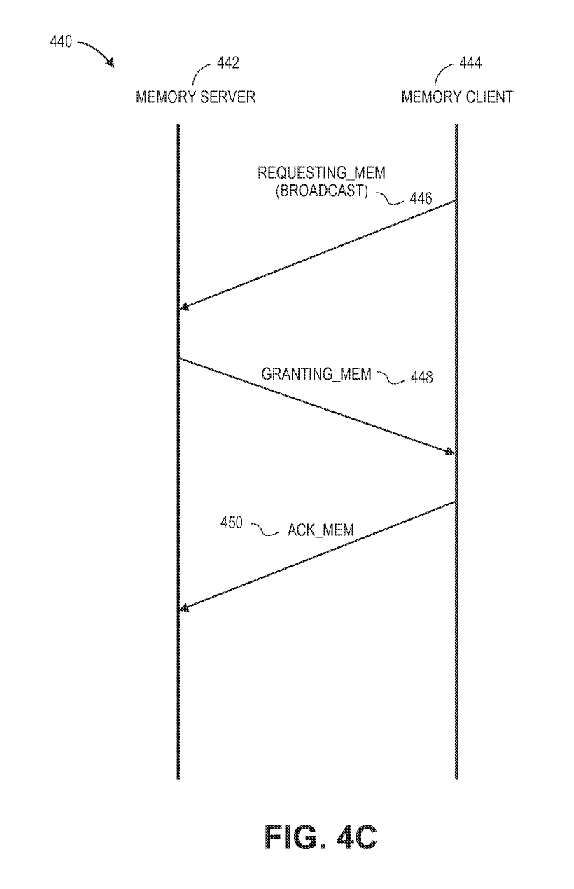

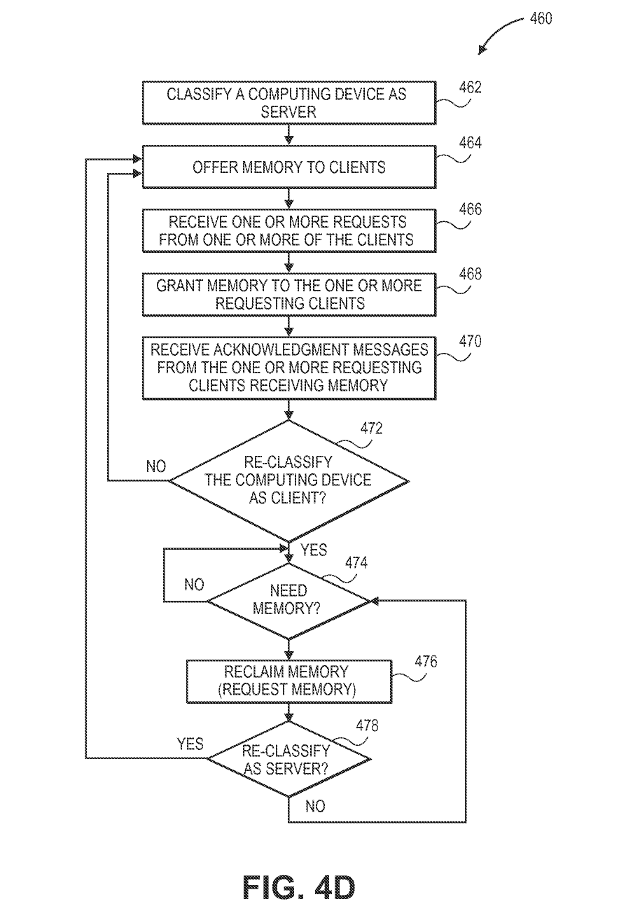

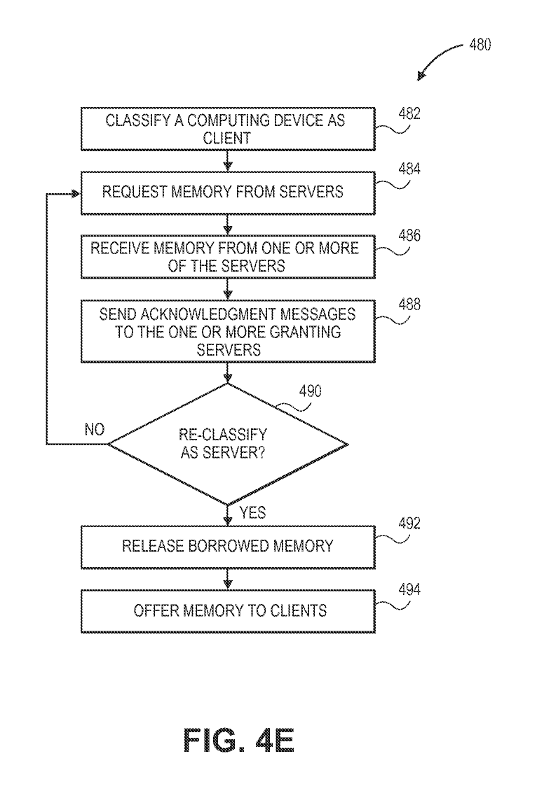

FIG. 2 illustrates memory collaboration mechanism employed at a computing device according to one embodiment of the invention. In one embodiment, memory collaboration mechanism 108 includes various components 202, 212, 214, 216, 218, 220, 222, 232 to facilitate dynamic memory sharing amount various computing devices, including remote computing devices (e.g., mobile computing devices, tablet computers, laptop computers, desktop computers, server computers, cluster-based computers, etc.). In the illustrated embodiment, the memory collaboration mechanism 108 includes a classification module 202 that is used to classify a computing device as a server or client as is further described with FIG. 4A. For example, one or more memory amount thresholds may be defined by the users of the computing devices representing a cluster of computing nodes within a network (e.g., cloud computing, Local Area Network (LAN), Wireless LAN (WLAN), Wide Area Network (WAN), Metropolitan Area Network (MAN), Personal Area Network (PAN), Internet, intranet, etc.).

If, for example, memory of a computing device dips below a minimum memory threshold, the computing device may be automatically classified as a memory client (e.g., a computing device that is short of memory and willing to obtain it) and conversely, if the computing device's memory is greater than a maximum memory threshold, the computing device may be automatically regarded as a memory server (e.g., a computing device that has excessive memory and is willing to share it). There may be other multiple thresholds that can automatically classify a computing device in a neutral zone (e.g., neither memory client nor memory server), such as when the memory amount is greater than the memory minimum high threshold, but lower than the memory maximum low threshold. These thresholds can be modified, added, removed or manipulated in anyway, as necessitated or desired, by the user or dynamically or automatically using one or more control algorithms. In other words, classification of computing devices (or nodes) can be performed dynamically or automatically with each computing device's changing memory amount that corresponding to the changing workload being processed by that computing device, so a memory client can, dynamically, become a memory server and vice versa or remain somewhere in the neutral zone or no change zone based on the available memory amount corresponding to the pending and/or anticipated workload.

The memory collaboration mechanism 108 further includes a memory acquisition protocol 212 whose components 214, 216, 218, 220, 222 provides various functionalities, such as a memory server offers its memory using an offer module 214. The memory server, upon receiving a request for memory from a memory client, grants its memory to the memory client using a grant module 218. The memory client requests the memory using a request module 216 and once the memory is received, the memory client acknowledges the received memory through an acknowledge module 220. The acknowledgment is realized by the memory server through its own acknowledge module 220. In one embodiment, a memory server, using the offer module 214, may broadcast its memory offer to any number of memory clients in a cluster so they may all know that the memory server has a particular amount of memory to offer to any memory client with interested in receiving it. In another embodiment, the memory offer, using the offer module 214, may be sent from the memory server to one or more memory clients (on a one-on-one direct communication basis as opposed to broadcasting the memory offer to all memory clients) based on the knowledge previously communicated to the memory server regarding the one or more memory clients seeking additional memory. This knowledge may be based on the memory requests received at the memory server from the one or more memory clients using the request module 216. As with the memory server, a memory client may also, using the request module 216, either broadcast its memory request to receive additional memory to any number of memory servers in the cluster or place a memory request with individual memory servers based on some previous knowledge, such as a memory offer broadcast by a particular memory server.

In one embodiment, the memory collaboration mechanism 108 further provides a reclaim module 222 so that if and when a memory server is reclassified as a memory client, in needs of memory, it can reclaim the memory previously granted to one or more memory clients. Further, a communication module 232 is employed by the memory collaboration mechanism 108 to facilitate bi- and multi-directional communication between memory servers and memory clients to perform the aforementioned functionalities and tasks (e.g., offering memory, requesting memory, granting memory, receiving memory, acknowledging receipt of memory, reclaiming previously granted memory, etc.). The communication module 232 may be associated with and use any number and types of interfaces and interconnects, such as Light Peak, Infiniband, Ethernet, Network Interface Controller (NIC), and the like.

It is contemplated that any number and type of components may be added to and removed from the memory collaboration mechanism 108 to facilitate dynamic and remote sharing of memory between computing devices. For brevity, clarity, ease of understanding and to focus on the memory collaboration mechanism 108, many of the standard or known components of a computing device are not shown or discussed here.

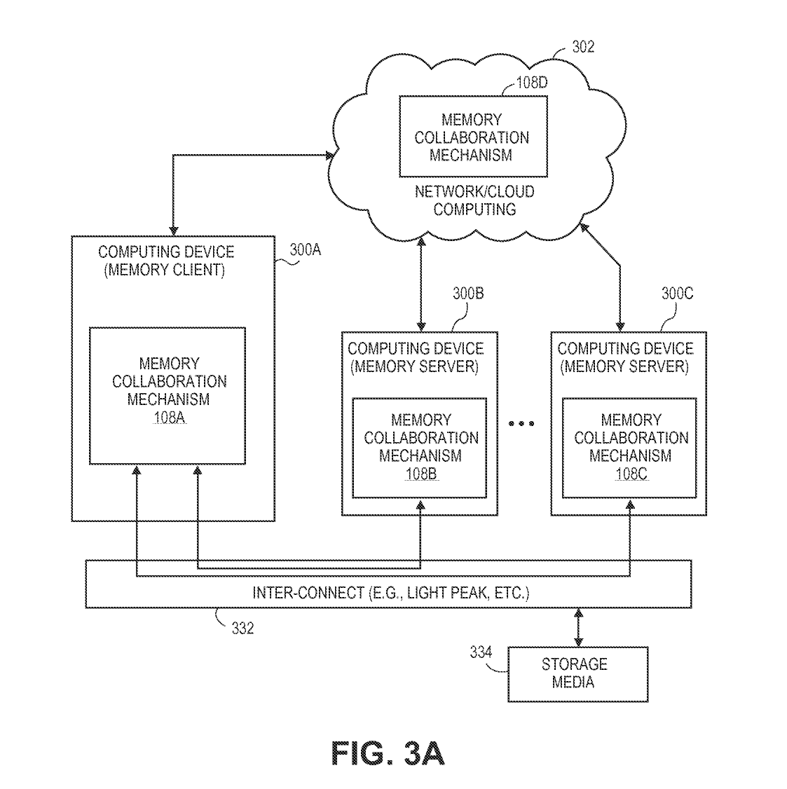

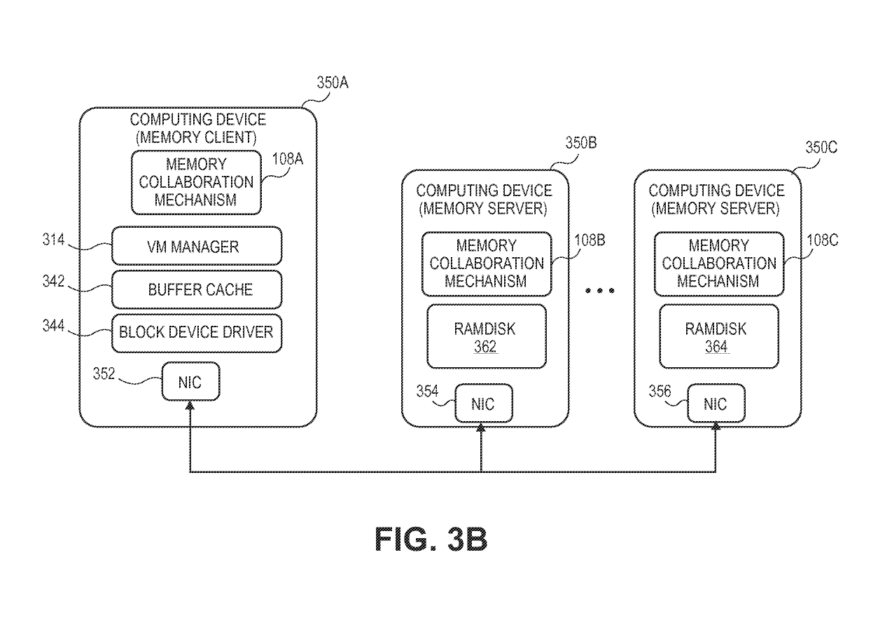

FIG. 3A illustrates memory collaboration mechanism facilitating dynamic and remote memory collaboration at computing devices according to one embodiment of the invention. In the illustrated embodiment, computing devices 300A, 300B, 300C are connected in a cluster over a network 302; for example, each computing device 300A, 300B, 300C is similar to or the same as computing device 100 FIG. 1. It is contemplated that a cluster can have any number, type and size of computing devices and that this cluster of computing devices 300A, 300B, 300C is illustrated here for simplicity, brevity, and ease of understanding. Each computing device 300A, 300B, 300C is shown as having employed memory collaboration mechanism 108A, 108B, 108C. In one embodiment, memory collaboration mechanism 108 may be distributed across all computing devices 300A, 300B, 300C in the cluster or, in another embodiment, memory collaboration mechanism 108D may be employed centrally at, for example, a server computing device over a network 302 and be accessible to the computing devices 300A, 300B, 300C through cloud computing, or the like. In yet another employed, one or more of the computing devices, such as computing devices 300A and 300B, may access the memory collaboration mechanism 108D, while computing device 300C may employ the memory collaboration mechanism 108C of its own. For example, the memory collaboration mechanism 108D may be responsible for managing and making decision for all or some of the computing devices 300A, 300B, 300C of the cluster, as necessitated.

In the illustrated embodiment and for example, computing device 300A is classified as memory client that employs one or more software applications or programs, an operating system (as the one shown in FIG. 1), a virtual machine (VM) manager, page, extend, other relevant and necessary components, etc., and, as aforementioned, the memory collaboration mechanism 108A. The other two computing devices 300B, 300C are classified as memory servers to communicate and grant memory, using the memory collaboration mechanism 108B and 108D, respectively, to the memory client 300A (classified as memory client) using its memory collaboration mechanism 108A and through a network connection technology, such as a network interconnect 332 (e.g., Light Peak, Infiniband, Ethernet, etc.). As described with reference to FIG. 2, various components of the memory collaboration mechanism 108A, 108B, 108C, 108D may be used to perform this remote memory sharing between the computing devices 300A, 300B, and 300C. Like memory client 300A, each of the memory servers 300B, 300C may employ one or more software applications or programs, an operating system (as the one shown in FIG. 1), a virtual machine (VM) manager, page, extend, other relevant and necessary components, etc., and, as aforementioned, the memory collaboration mechanism 108A.

In one embodiment, as aforementioned, communication (including granting and/or receiving of memory, transmitting and receiving of memory requests and acknowledgment messages, etc.) between the computing devices 300A, 300B, 300C may be facilitated by one or more communication modules of the one or more memory collaboration mechanisms 108A, 108B, 108C, 108D and through the interconnect (e.g., Light Peak, etc.) and paging and/or extending components employed at these computing devices 300A, 300B, 300C. For example, any communication between the memory client 300A and the memory server 300C may be performed through their respective paging components and the interconnect 332; similarly, communication between the memory client 300A and the memory server 300B may be performed through their respective extending components and the interconnect 332. Further, the three computing devices 300 may be in communication with and/or have access to storage 334 via the interconnect 332.

Now referring to FIG. 3B, it illustrates another embodiment of a cluster having computing devices 350A, 350B, 350C connected over a network using, for example, NICs 352, 354, 356, remote memory space swaps, etc. In one embodiment, each of computing devices 350A, 350B and 350C hosts memory collaboration mechanism 108A, 108B and 108C, respectively, to facilitate dynamic and remote memory sharing between the computing devices 350A, 350B, 350C. In the illustrated embodiment, memory servers 350B, 350C donate a portion of their memory space to the memory client 350A. If the memory client 350A runs short on its local memory, buffer cache 342, it can swap out pages to the remote servers 350B, 350C (e.g., having RAMDisks 362, 364) instead of the local hard disk drive. The memory client 350A is further shown as having other relevant components, such as an operating system, a VM manager 314 to manage virtual machines, a block device driver for storage of data, applications, etc., and the like. Each computing device 350A, 350B, 350C is similar to or the same as computing device 100 FIG. 1.

FIG. 4A illustrates a transaction sequence classification of computing devices for dynamic and remote memory collaboration according to one embodiment of the invention. Transaction sequence 400 may be performed by processing logic that may comprise hardware (e.g., circuitry, dedicated logic, programmable logic, etc.), software (such as instructions run on a processing device), or a combination thereof. In one embodiment, transaction sequence 400 may be performed by the memory collaboration mechanism of FIG. 1 and its components as described with reference to FIG. 2.

In one embodiment, a user may predetermine and set a number of memory amount thresholds 412, 414, 416, 418 to influence the classification of a computing device as a memory client 402 or a memory server 404. These thresholds 412, 414, 416, 418 may be set based on user desire or system needs, such as the types of software applications running on the computer device, etc., of the computing device. In the illustrated embodiment and for example, if the computing device's amount of memory falls below a threshold memory amount of low minimum 412, the computing device classified (or reclassified) as memory client 402 as determined by the classification module of the memory collaboration mechanism as shown in FIG. 2. If the computing device's memory amount is greater than a predetermined threshold of high minimum 414, the computing device may be regarded as neutral 406 because it is considered neither short of memory nor in excess of memory. If the computing device's memory amount remains between the low and high minimums 412, 414, the computing device is not regarded as needing a change and thus remains unchanged 408.

In one embodiment, the classification module also considers the high-end, maximum memory thresholds 416, 418. For example, if the computing device remains below the low maximum 416 amount of memory (but higher than the high minimum threshold 414), the computing device is promoted to neutral 408 (e.g., it is neither classified as memory client 402 nor as memory server 404). On the contrary, in one embodiment, if the computing device gains memory above the high maximum threshold 418, the computing device is classified (or reclassified) as memory server 404. Similar to the low and high minimum thresholds 412, 414, if the computing device's memory amount falls (or rises) between the low and high maximum thresholds 416, 418, the memory server 404 experience no change 410.

FIG. 4B illustrates a transaction sequence between a memory server and a memory client for dynamically and remotely collaborating memory according to one embodiment of the invention. Transaction sequence 420 may be performed by processing logic that may comprise hardware (e.g., circuitry, dedicated logic, programmable logic, etc.), software (such as instructions run on a processing device), or a combination thereof. In one embodiment, transaction sequence 420 may be performed by the memory collaboration mechanism of FIG. 1 and its components as described with reference to FIG. 2.

In one embodiment, once classified, memory server 422 offers 426 its memory for use by any number of available memory clients. The memory server 422 may broadcast its intention to offer memory to a number of memory clients by broadcasting the intention or offer 426 using, for example, the offer module of the memory collaboration mechanism of FIG. 2. In one embodiment, memory client 424 broadcasts its request 428 for memory to a number of memory servers, including memory server 422, using the request module of the memory collaboration mechanism. In response to the request 428, the memory server 422 grants 430 an amount of memory to the memory client 424, while the memory client 424 issues an acknowledgement message 432 to the memory server 422 to acknowledge the receipt of memory from the memory server 422. In one embodiment, granting of memory 430 and transmitting of acknowledgement 432 are performed by the grant module and the acknowledgement module, respectively, of the memory collaboration mechanism of FIG. 2.

FIG. 4C illustrates a transaction sequence between a memory server and a memory client for dynamically and remotely collaborating memory according to one embodiment of the invention. Transaction sequence 440 may be performed by processing logic that may comprise hardware (e.g., circuitry, dedicated logic, programmable logic, etc.), software (such as instructions run on a processing device), or a combination thereof. In one embodiment, transaction sequence 440 may be performed by the memory collaboration mechanism of FIG. 1 and its components as described with reference to FIG. 2

In one embodiment, client memory 444 broadcasts a memory request 446 for memory to any number of memory servers using the request module of the memory collaboration mechanism of FIG. 2. In response to the memory request 446, memory server 442 grants memory 448 to the memory client 444, while the memory client 444 responds back to the memory server 442 with an acknowledgement message 450 in order to acknowledge the receipt of the memory at the memory client 444. In one embodiment, granting of memory 448 and sending of acknowledgement 450 are performed by the grant module and the acknowledgement module, respectively, of the memory collaboration mechanism of FIG. 2.

FIG. 4D illustrates a method for facilitating dynamic and remote memory collaboration between computing devices according to one embodiment of the invention. Method 460 may be performed by processing logic that may comprise hardware (e.g., circuitry, dedicated logic, programmable logic, etc.), software (such as instructions run on a processing device), or a combination thereof. In one embodiment, method 460 may be performed by the memory collaboration mechanism of FIG. 1 and its components as described with reference to FIG. 2.

Method 460 begins with block 462 with a computing device of a cluster of computing devices connected or in communication with each other over a network being classified as memory server. At block 464, the classified memory server offers memory to any number of computing devices classified as memory clients. At block 466, requests for memory are received at the memory server from one or more of the memory clients. At block 468, the memory server grants memory to the one or more memory clients. The memory server than receives acknowledgement messages from the one or more memory clients at block 470.

In one embodiment, at block 472, a determination is made as to whether the memory server by reclassified as memory client (or, e.g., neutral, etc.). If the memory server remains as memory server, nothing may change or the process may continue with the memory server offering more memory at block 464. If the memory server is reclassified as a memory client, the process may continue with another determination as to whether the reclassified memory client requires or needs memory at block 474. If not, nothing may change or the process may continue at block 474. If yes, at block 474, the reclassified memory client reclaims the previously granted memory to the one or more memory clients at block 476. The reclaiming may be performed using the reclaim module 222 of the memory collaboration mechanism of FIG. 2. At block 478, another determination is made as to whether the reclassified memory client be reclassified as memory client. If not, the process continues in any number of ways, such as with block 474. If yes, the process may continue with offering of the memory at block 464.

FIG. 4E illustrates a method for facilitating dynamic and remote memory collaboration between computing devices according to one embodiment of the invention. Method 480 may be performed by processing logic that may comprise hardware (e.g., circuitry, dedicated logic, programmable logic, etc.), software (such as instructions run on a processing device), or a combination thereof. In one embodiment, method 480 may be performed by the memory collaboration mechanism of FIG. 1 and its components as described with reference to FIG. 2.

Method 480 begins at block 482 with classification of a computing device of a cluster of computing devices connected over a network as memory client. At block 484, the memory client broadcasts it request for memory to computing devices of the cluster classified as memory servers. At block 486, the memory client receives memory from and granted by one or more memory servers. At block 488, the memory client sends acknowledgements messages to the one or more memory servers that granted it their memory. At block 490, a determination is made as to whether the memory client be reclassified as memory server. If not, the process may remain unchanged or continue with requesting more memory at block 484. If yes, at block 492, the reclassified memory server may release the previously received memory back to the one or more granting memory servers. Further, at block 494, the newly reclassified memory server may offer its excess memory to any number of memory clients.

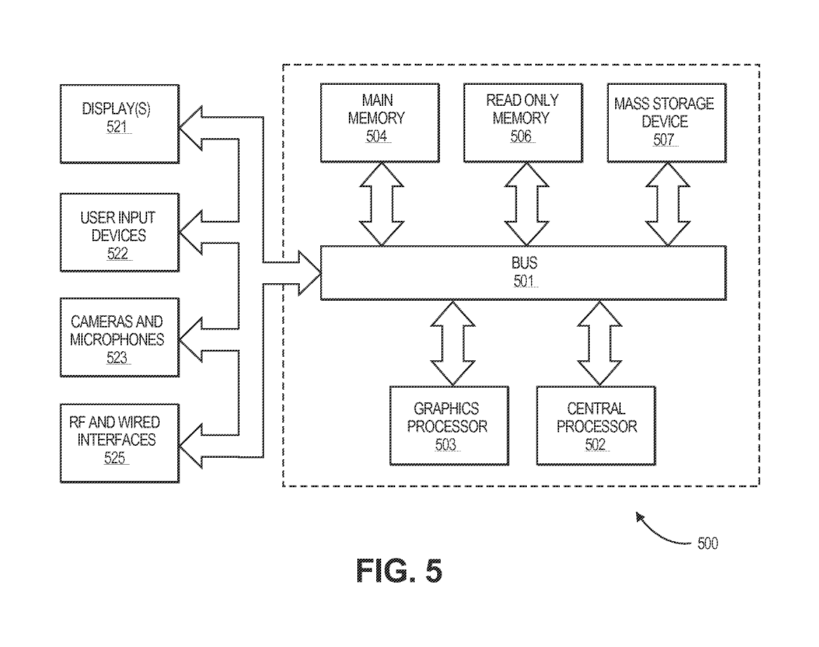

FIG. 5 illustrates a computing system 500 employing and facilitating memory collaboration mechanism according to one embodiment of the invention. The exemplary computing system 500 may be the same as or similar to computing devices 100, 300A, 300B, 300C and 350A, 350B, 350C of FIGS. 1, 3A and 3B, respectively. The computer system 500 includes a bus or other communication means 501 for communicating information, and processing means such as a microprocessor 502 coupled with the bus 501 for processing information. The computer system 500 may be augmented with a graphics processor 503 for rendering graphics through parallel pipelines and may be incorporated into one or more central processor(s) 502 or provided as one or more separate processors.

The computer system 500 further includes a main memory 504, such as a RAM or other dynamic data storage device, coupled to the bus 501 for storing information and instructions to be executed by the processor 502. The main memory also may be used for storing temporary variables or other intermediate information during execution of instructions by the processor. The computer system 500 may also include a nonvolatile memory 506, such as a Read-Only Memory (ROM) or other static data storage device coupled to the bus 501 for storing static information and instructions for the processor.

A mass memory 507 such as a magnetic disk, optical disc, or solid state array and its corresponding drive may also be coupled to the bus 501 of the computer system 500 for storing information and instructions. The computer system 500 can also be coupled via the bus to a display device or monitor 521, such as a Liquid Crystal Display (LCD) or Organic Light Emitting Diode (OLED) array, for displaying information to a user. For example, graphical and textual indications of installation status, operations status and other information may be presented to the user on the display device 521, in addition to the various views and user interactions discussed above.

Typically, user input devices 522, such as a keyboard with alphanumeric, function and other keys, etc., may be coupled to the bus 501 for communicating information and command selections to the processor 502. Additional user input devices 522 may include a cursor control input device such as a mouse, a trackball, a trackpad, or cursor direction keys can be coupled to the bus for communicating direction information and command selections to the processor 502 and to control cursor movement on the display 521.

Camera and microphone arrays 523 are coupled to the bus 501 to observe gestures, record audio and video and to receive visual and audio commands as mentioned above.

Communications interfaces 525 are also coupled to the bus 501. The communication interfaces may include a modem, a network interface card, or other well-known interface devices, such as those used for coupling to Ethernet, token ring, or other types of physical wired or wireless attachments for purposes of providing a communication link to support a LAN or WAN, for example. In this manner, the computer system 500 may also be coupled to a number of peripheral devices, other clients, or control surfaces or consoles, or servers via a conventional network infrastructure, including an Intranet or the Internet, for example.

It is to be appreciated that a lesser or more equipped system than the example described above may be preferred for certain implementations. Therefore, configuration of the computing system 500 may vary from implementation to implementation depending upon numerous factors, such as price constraints, performance requirements, technological improvements, or other circumstances.

Embodiments may be implemented as any or a combination of: one or more microchips or integrated circuits interconnected using a parent-board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware, such as firmware.

Embodiments may be provided, for example, as a computer program product which may include one or more machine-readable media, such as a non-transitory machine-readable medium, having stored thereon machine-executable instructions that, when executed by one or more machines such as a computer, such as computing system 500, network of computers, or other electronic devices, may result in the one or more machines carrying out operations in accordance with embodiments of the present invention. A machine-readable medium may include, but is not limited to, floppy diskettes, optical disks, Compact Disc-ROMs (CD-ROMs), and magneto-optical disks, ROMs, RAMs, Erasable Programmable Read-Only Memories (EPROMs), EEPROMs Electrically Erasable Programmable Read-Only Memories (EEPROMs), magnetic or optical cards, flash memory, or other type of media/machine-readable medium suitable for storing machine-executable instructions, such as solid state storage devices, fast and reliable DRAM sub-systems, etc.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

In the foregoing specification, the invention has been described with reference to specific exemplary embodiments thereof. It will, however, be evident that various modifications and changes may be made thereto without departing from the broader spirit and scope of the invention as set forth in the appended claims. The Specification and drawings are, accordingly, to be regarded in an illustrative rather than a restrictive sense.

1. A method comprising:
dynamically classifying a computing device of a plurality of computing devices as a memory server, wherein the plurality of computing devices are coupled to each other over a network;
offering, by the memory server, of memory to be used by one or more of the plurality of computing devices classified as one or more memory clients; and
remotely granting, by the memory server, of the memory to the one or more memory clients.

2. The method of claim 1, further comprising:
receiving, at the memory server, one or more requests for the memory from the one or more memory clients; and
receiving, at the memory server, one or more acknowledgement messages from the one or more memory clients to acknowledge receipt of the memory at the one or more memory clients.

3. The method of claim 1, wherein dynamically classifying comprises reclassifying the memory sever as a memory client upon detecting a change in memory amount at the memory server, wherein the change comprises the memory amount dropping below a predetermined minimum memory threshold, wherein the reclassified memory client to reclaim, from the one or more memory clients, the granted memory, wherein the memory server remains neutral when the memory amount remains between the predetermined minimum memory threshold and a predetermined maximum memory threshold.

4. (canceled)

5. The method of claim 1, wherein dynamically classifying further comprises reclassifying the one or more memory clients as one or more memory servers upon detecting a change in memory amount at the one or more memory clients, wherein the change comprises the memory amount rising above the predetermined maximum memory threshold.

6. The method of claim 1, wherein offering comprises broadcasting by the memory server to all of the one or more memory clients, wherein offering further comprises directly and selectively communicating the offering by the memory server to each of the one or more memory clients.

7. The method of claim 1, further comprising employing a memory collaboration logic unit at one or more of the plurality of computing devices or another computing device in communication with the plurality of computing devices over a network or via cloud computing.

8. (canceled)

9. A system comprising:
a computing device having a memory to store instructions for facilitating dynamic and remote memory collaboration, and a processing device to execute the instructions, wherein the instructions cause the processing device to:
dynamically classify the computing device of a plurality of computing devices as a memory server, wherein the plurality of computing devices are coupled to each other over a network;
offer memory to be used by one or more of the plurality of computing devices classified as one or more memory clients; and
remotely grant the memory to the one or more memory clients.

9.-30. (canceled)

31. The system of claim 9, wherein the processing device is further to:
receive, at the memory server, one or more requests for the memory from the one or more memory clients; and
receive, at the memory server, one or more acknowledgement messages from the one or more memory clients to acknowledge receipt of the memory at the one or more memory clients.

32. The system of claim 9, wherein dynamically classifying comprises reclassifying the memory sever as a memory client upon detecting a change in memory amount at the memory server, wherein the change comprises the memory amount dropping below a predetermined minimum memory threshold, wherein the reclassified memory client to reclaim, from the one or more memory clients, the granted memory, wherein the memory server remains neutral when the memory amount remains between the predetermined minimum memory threshold and a predetermined maximum memory threshold.

33. The system of claim 9, wherein dynamically classifying further comprises reclassifying the one or more memory clients as one or more memory servers upon detecting a change in memory amount at the one or more memory clients, wherein the change comprises the memory amount rising above the predetermined maximum memory threshold.

34. The system of claim 9, wherein offering comprises broadcasting by the memory server to all of the one or more memory clients, wherein offering further comprises directly and selectively communicating the offering by the memory server to each of the one or more memory clients.

35. The system of claim 9, wherein the processing device is further to employ a memory collaboration logic unit at one or more of the plurality of computing devices or another computing device in communication with the plurality of computing devices over a network or via cloud computing.

36. A computer-readable media comprising instructions stored thereon which, if executed by a computer, cause the computer to:
dynamically classify a computing device of a plurality of computing devices as a memory server, wherein the plurality of computing devices are coupled to each other over a network;
offer, by the memory server, of memory to be used by one or more of the plurality of computing devices classified as one or more memory clients; and
remotely grant, by the memory server, of the memory to the one or more memory clients.

37. The computer-readable media of claim 36, wherein the computer is further to:
receive, at the memory server, one or more requests for the memory from the one or more memory clients; and
receive, at the memory server, one or more acknowledgement messages from the one or more memory clients to acknowledge receipt of the memory at the one or more memory clients.

38. The computer-readable media of claim 36, wherein dynamically classifying comprises reclassifying the memory sever as a memory client upon detecting a change in memory amount at the memory server, wherein the change comprises the memory amount dropping below a predetermined minimum memory threshold, wherein the reclassified memory client to reclaim, from the one or more memory clients, the granted memory, wherein the memory server remains neutral when the memory amount remains between the predetermined minimum memory threshold and a predetermined maximum memory threshold.

39. The computer-readable media of claim 36, wherein dynamically classifying further comprises reclassifying the one or more memory clients as one or more memory servers upon detecting a change in memory amount at the one or more memory clients, wherein the change comprises the memory amount rising above the predetermined maximum memory threshold.

40. The computer-readable media of claim 36, wherein offering comprises broadcasting by the memory server to all of the one or more memory clients, wherein offering further comprises directly and selectively communicating the offering by the memory server to each of the one or more memory clients.

41. The computer-readable media of claim 36, wherein the computer is further to employ a memory collaboration logic unit at one or more of the plurality of computing devices or another computing device in communication with the plurality of computing devices over a network or via cloud computing.

42. An apparatus comprising:
a processor running on an operating system at a computing device, the operating system coupled to a memory collaboration logic unit to perform memory collaboration, wherein the memory collaboration logic unit comprises:
a classification module to dynamically classify the computing device of a plurality of computing devices as a memory server, wherein the plurality of computing devices are coupled to each other over a network;
an offer module to offer memory to be used by one or more of the plurality of computing devices classified as one or more memory clients; and
a grant module to remotely grant the memory to the one or more memory clients.

43. The apparatus of claim 42, wherein the memory collaboration logic unit further comprises:
a communication module to receive, at the memory server, one or more requests for the memory from the one or more memory clients; and
the communication module to receive, at the memory server, one or more acknowledgement messages from the one or more memory clients to acknowledge receipt of the memory at the one or more memory clients.

44. The apparatus of claim 42, wherein the classification module is further to reclassify the memory sever as a memory client upon detecting a change in memory amount at the memory server, wherein the change comprises the memory amount dropping below a predetermined minimum memory threshold, wherein the reclassified memory client to reclaim, from the one or more memory clients, the granted memory, wherein the memory server remains neutral when the memory amount remains between the predetermined minimum memory threshold and a predetermined maximum memory threshold.

45. The apparatus of claim 42, wherein the classification module is further to reclassify the one or more memory clients as one or more memory servers upon detecting a change in memory amount at the one or more memory clients, wherein the change comprises the memory amount rising above the predetermined maximum memory threshold.

46. The apparatus of claim 42, wherein the offer module is further to broadcast by the memory server to all of the one or more memory clients, wherein offering further comprises directly and selectively communicating the offering by the memory server to each of the one or more memory clients.

47. The apparatus of claim 42, wherein the memory collaboration logic unit is employed at one or more of the plurality of computing devices or another computing device in communication with the plurality of computing devices over a network or via cloud computing.
